(19) United States
(12) Patent Application Publication
(10) Pub. No.: US 2012/0137332 A1
(43) Pub. Date: May 31, 2012

(54) MOBILE TV DELIVERY SYSTEM

(76) Inventor: Pranay Kumar, Kanata (CA)

(21) Appl. No.: 13/305,656

(22) Filed: Nov. 28, 2011

Related U.S. Application Data
(60) Provisional application No. 61/344,947, filed on Nov. 26, 2010.

(51) Int. Cl. H04N 21/65

(52) U.S. Cl. 725/62

(57) ABSTRACT

Systems and methods are disclosed that include a distribution unit for delivering content to a mobile device. This system includes an input for receiving an input signal comprising a multimedia content, an authentication module that is configured permit authentication of a mobile device to view the multimedia content, and a signal processing and conversion module for transcoding the multimedia content for a destination platform. This system also includes a delivery system for distributing the multimedia content.

### CROSS-REFERENCE TO RELATED APPLICATIONS

This application claims priority under 35 U.S.C. §119(e) to U.S. Patent Application Ser. No. 61/344,947 entitled “Mobile TV system and device”, filed on Nov. 26, 2010, which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure relates generally to systems and methods for delivering multimedia content to various devices, and more specifically to making television channels available to mobile devices.

### BACKGROUND OF THE INVENTION

Providing television media using a wireless packetized network continues to be a challenge for carriers. Compromises in the quality of video, limited channel availability, and other service problems continue to inhibit the effective distribution of television media using the packetized network. Systems and methods of effective distribution of television media using the packetized network are needed.

### SUMMARY OF THE INVENTION

In some embodiments, systems and methods are disclosed that include a distribution unit for delivering content to a mobile device. This system includes an input for receiving an input signal comprising a multimedia content, an authentication module that is configured permit authentication of a mobile device to view the multimedia content, and a signal processing and conversion module for transcoding the multimedia content for a destination platform. This system also includes a delivery system for distributing the multimedia content.

In another embodiment, a system for distributing content to a plurality of devices, including a control node and a plurality of distribution units in communication with the control node. The plurality of distribution units are configured to provide Mobile TV to at least one receiving device. The control node provides information relating to the account status of the at least one receiving device and designates content from which the at least one receiving device may select.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a diagram showing a plurality of units providing content wirelessly to at least one content receiver according to one embodiment of the present disclosure;

FIG. 2 is a schematic of a Mobile TV delivery system using distribution units, according to one embodiment of the present disclosure;

FIG. 3 is a schematic of a Mobile TV delivery system using a distribution unit and separate WAP (Wireless Access-Point) functionality, according to one embodiment of the present disclosure;

FIG. 4 is a detailed functional block diagram of one embodiment of a distribution unit consistent with the distribution unit of FIG. 2 according to one embodiment of the present disclosure;

FIG. 5 is a communications flow diagram between elements of the delivery system of FIG. 2 according to one embodiment of the present disclosure;

FIG. 6 is a flowchart of the functional steps followed by the system of FIG. 2 according to one embodiment of the present disclosure; and

FIG. 7 is a block diagram of one hardware configuration of the computer controller in a distribution unit.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

The present disclosure, in some embodiments, provides systems and methods for distributing media to various devices using a packetized network. A plurality of transmitters or transceivers may be positioned to distribute content or media, such as multimedia content substantially similar to television channels in the form of Mobile TV. The content may, in some embodiments, be controlled by a central content controller or a distributed content controller. The content controller may provide identification parameters to at least one receiving device indicating what content the at least one receiving device is authorized to receive. The plurality of transmitters or transceivers may be of a homogenous or heterogeneous type, with various techniques of transmission employed based upon the type of medium to be used for distribution. The receiving device may be any kind of device, such as a mobile telephone, a tablet, or a personal computer capable of receiving a packetized stream of data. Through the positioning of the plurality of transmitters, media may be delivered to a plurality of devices. This media may include video, audio, multimedia, data, images or any other transfer of data from the plurality of transmitters or transceivers. For the purpose of clarity, these video, audio, multimedia, data, images, or other transfers of data shall be known as non-limiting examples of “Mobile TV”.

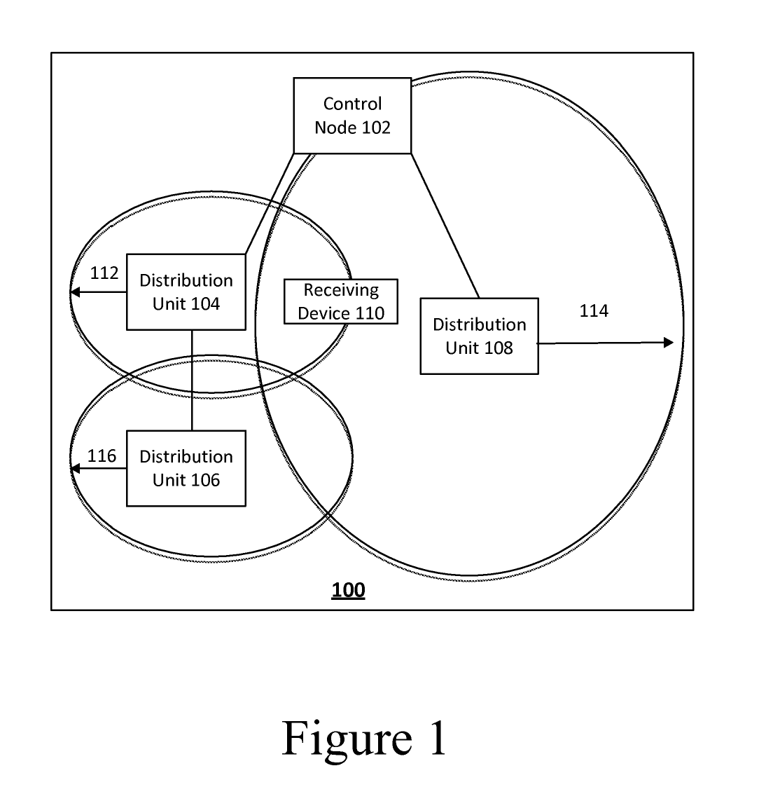

It is expressly recognized that the basic challenges and processes in offering Mobile TV include, but are not limited to, real time conversion of a video signal to IP (Internet Protocol) based packet stream, multicasting content, cost prohibitive use of expensive frequency spectrum, and channel switching process. FIG. 1 is an example of a system 100 using elements of the present disclosure which is capable of overcoming these challenges through the embodiments disclosed herein.

FIG. 1 illustrates a system 100 for delivering content to a device according to one embodiment of the present disclosure using an IP data stream. In FIG. 1, a control node 102 is connected to a first distribution unit 104, a second distribution unit 108, and coupled to a third distribution unit 106. Each of these distribution units 104, 106, 108 has a range illustrated by a first radius 112 for the first distribution unit 104, a second radius 114 for the second distribution unit 108, and a third radius 116 for the third distribution unit 106. A receiving device 110 is shown capable of receiving signals from the first distribution unit 104 and/or the second distribution unit 108. The receiving device 110 is capable of receiving Mobile TV from the first distribution unit 104 and/or the second distribution unit 108. It is understood that the receiving device 110 may receive signals from one or both of the first distribution unit 104 and the second distribution unit 108. It is understood that one of the advantages of receiving signals from both the first distribution unit 104 and the second distribution unit 108 is that the receiving device 110 can be seamlessly handed over between the first distribution unit 104 and the second distribution unit 108 as well as provide for failure-avoidance in the event of a failure in either the first distribution unit 104 or the second distribution unit 108. The distribution of Mobile TV from the first distribution unit 104 and the second distribution unit 108 shall be performed consistent with the various embodiments disclosed here.

A control node 102 may be used to provide information to the distribution unit 104, 106, 108 relating to, but not limited to, account information of the receiving device 110, content for the distribution unit 104, or other information used by the distribution unit 104, 106, 108 to distribute Mobile TV. The control node 102 may also be used to collect information relating to, but not limited to, usage, advertising, billing, or other administrative functions for a Mobile TV service. The control node 102 may be integrated into separate distribution unit 104, 106, 108 or may reside a separate discrete element. The control node 102 may also be integrated into a cable operator system. The receiving device 110 may communicate directly or indirectly with the control node 102 to obtain authorization to display certain media transmitted by the first, second, and third distribution units or perform other various functions disclosed herein. The various embodiments disclosed herein using the distribution units overcome the previously discussed limitations in content distribution. The combination of at least one distribution unit and the control node 102 may, in some embodiments, constitute a “distribution unit platform” capable of distributing Mmobile TV to a plurality of receiving devices.

The distribution unit 104, 106, 108 are, in some embodiments, a device comprising at least one content input and one wireless transmitter for transmitting Mobile TV. The content input for the distribution unit 104, 106, 108 may be, but is not limited to, coax cable, Ethernet, satellite, fiber, or any other medium capable of transmitting content into the distribution unit 104, 106, 108. The wireless transmitter may be any wireless technique, including, but not limited to, the IEEE 802.11 or 802.16 standards, a global system for mobile communications (GSM) or code division multiple access (CDMA) technique, or other technique of transmitting Mobile TV without a physical connection between the distribution unit 104, 106, 108 and the receiving device 110. It is understood that the distribution unit 104, 106, 108 could be integrated into or with any device, including, but not limited to a cable TV signal-processing device (CSPD).

In some embodiments, the distribution unit 104, 106, 108 has multiple functions including tuning, decoding/demodulation, decryption/encryption/re-encryption, video transcoding, IP marketization functions, and providing wireless signals comprising Mobile TV enabling a receiving device 110 to display content. The distribution unit 104, 106, 108 may be powered by any external power mechanism or, in some embodiments, may be bus powered using technologies including, but not limited to, coaxial cabling, serial bus powered connections, or power over Ethernet (PoE). In yet other embodiments, the distribution unit 104, 106, 108 may be powered without external connections using a combination of solar and battery powered elements, such that the distribution unit 104, 106, 108 may connect to the control node and the receiver using only wireless connections. For example, and without limitation, the distribution unit 104, 106, 108 may connect to the receiving device 110 using a 802.11 wireless connection, the control node 102 using a cellular data signal, and use a satellite as a content input. In this way, the distribution unit 104, 106, 108 is able to leverage the relative strength of each connection while simultaneously providing wireless Mobile TV to a plurality of receiving units, which may, for exemplary purposes, be represented as receiving device 110. It is understood that one of the advantages of the present system is that the distribution unit 104, 106, 108 is configured to multicast an IP data stream comprising Mobile TV to a plurality of receiving units using the internal connection such that a local signal in an unlicensed frequency range, such as 802.11, with a broad available bandwidth. In this way, the distribution unit 104, 106, 108 is configured to provide Mobile TV to the receiving device 110 using the unlicensed frequency spectrum while at the same time maintaining the ability to be coupled with existing cellular networks in the event of signal interference, signal failure, or other impediment where it may be advantageous to couple the distribution unit 104, 106, 108 with a cellular network.

It is expressly understood that the distribution unit 104, 106, 108 may be modular. For example, the some functions of the distribution unit may be distributed to the control node 102 or other distribution units. For example, implementations of the functions of channel tuning, QAM demodulation, MPEG stream descrambling and demultiplexing, buffering, transcoding, re-encryption, and transmission to the mobile device may exist in separate functional units, or in any combination. Conversely, it is also understood that the control node 102 and the distribution unit 104 may be combined into a single unit. It is further understood that while a single control node 102 is illustrated in FIG. 1, a plurality of control nodes may be present, and that one control node 102 may function as both a distribution unit and a control node while still connected to a plurality of distribution nodes, control nodes, or other units.

In some embodiments, the distribution unit utilizes one of many mounting methods. These include, but are not limited to, pole-mounting, strand-mounting, vault-mounting, rack-mounting, street-sign mounting, building corner-mounting, wall-mounting, roof-mounting, ceiling-mounting, stadium under-seat-mounting. Each of the mounting types may require a detailed design for the mounting bracket and/or casing involved. In the case of vault mounting, the vault in which the distribution unit 104, 106, 108 may be mounted, may be underground. It is understood that mounting a distribution unit 104, 106, 108 underground may pose a severe limitation on the strength and reach of the wireless coverage provided by the distribution unit 104, 106, 108. In one embodiment used to solve the issue of low coverage in vault mount scenarios, the distribution unit 104, 106, 108 may be located in the vault and the radios and/or antennae will be mounted to a pole that will stick outside of the vault, above-ground, in order to provide an effective wireless coverage area.

In some embodiments, the distribution unit comprises quality of service (QoS) metrics, such as dropped frames, effective throughput, or other metrics capable of being used to determine the relative quality of content delivered to the receiving device 110. In these embodiments, the distribution unit may direct the receiving device 110 to use an alternative input for the obtaining the content. In other embodiments, the receiving unit may maintain information about all available distribution units within receiving range, and may select either the distribution unit with the fastest effective throughput, the least number or most number of other users, or the distribution unit that meets a specific user designated criteria. For example, there may be a data cost associated with connecting through a specific wireless technique provided by the distribution unit 104, 106, 108, and a receiving device 110 may select a lower bandwidth option to reduce costs. In some embodiments the selection of the distribution unit 104, 106, 108 may be initiated based on physical location of the receiving device 110, such as might be determined by a GPS receiver within the receiving device 110, and communicated to the at least one control node 102 or distribution node 104, 106, 108.

The receiving device 110 is understood to be any device capable of receiving Mobile TV content. In some embodiments, the receiving device may be a mobile telephone, a tablet, a notebook computer, or any other device capable or receiving Mobile TV content. In some embodiments, the receiving device may be configured to communicate with the distribution node 104, 106, 108 or control node 102. The receiving device 110 in preferable embodiments comprising a screen to display Mobile TV content and audio output capabilities, such as a speaker, to output audio from the Mobile TV. In alternative embodiments the receiving device 110 may only comprise speakers capable of outputting audio related to the Mobile TV.

One of the advantages of the present system is that the system 100 is capable of being integrated with or offers confluence with the various sources of content, including, but not limited to, terrestrial cable TV, fiber-optic communications network, and satellite TV. Such content may include basic channel programming and extended channel programming cable TV packages, High Definition (HD) programming, pay-per-view (PPV) event subscriptions, video-on-demand (VOD) and others.

The distribution platform may be used to provide analytics services to track user behavior and consumption habits. Examples of desirable metrics of content consumption include, but are not limited to, identity of the consumer as identified by, for instance, MAC address, “set-top” credentials or cellular International Mobile Equipment Identity (IMEI), electronic serial number (ESN), or Mobile Equipment IDentifier (MEID) or other stored credentials specific to the distribution unit service, types of video consumed, time of consumption, minutes of content consumed, location of consumption, quality of service, and device used to consume content.

In some embodiments, the distribution platform may also provide an e-commerce platform for the sale of Mobile TV related content and other applications for installation and use on the user/subscriber's device. The distribution platform may also provide the ability to insert and/or overlay advertising into the content delivered to the end-user “on-the-fly”. The advertising content may be delivered to the distribution unit through a remote server or through a control node 102. The advertising content may be selected for delivery based on the results of the aforementioned analytics services or other consumer-specific information in order to provide targeted advertising, such as, but not limited to, location-based advertising. The advertising may be selected “on-the-fly” such as, but not limited to, by ingesting, processing, analyzing, and searching the video picture frames in the delivered video content to detect elements for targeted advertising. As a very specific example, videos being consumed of a well-known sports-figure wearing branded clothing or sporting gear may be detected by the distribution unit platform, and the articles of clothing/gear may be advertised to the end-user. Location based advertising includes using the location of a viewer/subscriber in order to create and deliver targeted advertising content that may be of higher interest or relevance for the subscriber, based on his or her location.

One specific example includes advertising for venues/restaurants/shops in a mall since these venues are in the vicinity of a subscriber who happens to be in that mall. Overlay advertising may consist of any advertising in any form such as, but not limited to, text, pictures, picture-in-picture videos, pop-ups, and URLs, in a layer on top of the delivered content, video, and static images. The delivered video content may be left unaltered, as the overlaying function can be achieved on the user's device. The end result may look like a video with a clickable advertisement superimposed over the Mobile TV content displayed on the receiving device 110 screen.

Apart from some clear-channel and/or free-broadcast channels these services typically are delivered on the cable TV network as content protected by a conditional access (CA) system. CA systems are employed in various wireless systems, including systems whereby a digital stream of data is used to display data. For exemplary nonlimited purposes, in the United States one example of a CA system may refer the standard for conditional access that is provided with CableCARDs whose specification was developed by the cable company consortium CableLabs. For the purposes of clarity and completeness, the CableLabs specification is hereby incorporated by reference. CA system as employed in today's MPEG-Transport Stream video delivery architectures typically employs an encryption/decryption codeword (CW), used to encrypt and decrypt the video stream, encrypted entitlement control message (ECM) messages in-band with content streams that allow frequent change of the CWs, and less frequent entitlement management message (EMM) messages to specific subscriber devices that in turn contain decryption keys for ECMs. Databases and servers in the operator's operations network and subscriber management systems correlate subscribers, subscriber's physical device identifier (for set-top box, cable-modem, etc.), and subscribed services to control a conditional access entitlement-message server, which coordinates the sending of EMMs and ECMs to subscriber devices, thus allowing them unencrypted access to the service. Authenticated and/or encrypted communication between a subscriber device and the CA system (and other elements of the cable TV control network) may be enabled through a unique device identifier and a secret code stored in the device at manufacture and known to the CA system, together comprising the credentials for the subscriber device. CA systems may be employed in various wireless systems, including systems whereby a digital stream of data is used to display data.

In a typical Cable VoD system, for example, the set-top credentials are passed with user requests to the VoD system, the VoD system verifies the credentials, potentially transmits billable events on the user's account to the billing system, sets up the video stream, and enables entitlement-message generation to the user's set-top so that content can be de-crypted.

The distribution unit 104, 106, 108 content may be transmitted by the cable operator in 6 MHz wide bands. Each of these bands can carry either DOCSIS (Digital Over Cable Service Interface Specification) data, analog programming, high definition (HD) digital signals, and standard definition (SD) digital signals. The distribution unit will operate with HD and SD content as well as with the DOCSIS data. There are 8 to 10 SD programs that are multiplexed on a single 6 MHz band giving each program an effective bandwidth of 3.33 to 4.13 Mbps. There are 3 to 4 HD programs that are multiplexed on a single 6 MHz band giving each program an effective bandwidth of 8.25 to 10 Mbps. Each of these programs are scrambled by the Multiple Service/System Operator (MSO) before getting multiplexed on the band using CA to ensure that only authorized users are able to view the content. This enables the MSO to manage the rights of the content.

The distribution unit is also capable of providing near instant channel changes. By being physically close to the end-users, the distribution unit approach has an additional advantage over centralized approach to enable delivery of a high quality of service and fast channel changes. Faster channel changes, more specifically, instantaneous channel changes (ICC), mean that the change in channel occurs in such a way that the human eye (user) does not detect the change. For example there is no “black screen” or delay during the channel change process. This requires the channel change event (as seen on a screen) should take no more than between 200 milliseconds and 500 milliseconds delay in order to be “instantaneous”. In order to achieve this effect, ICC may be performed in a plurality of ways. For example, and without limitation, the ICC may be performed by placing a plurality of tuners or a single tuner capable of tuning simultaneously to a plurality of frequencies at either the control node or one of the distribution nodes. If the single tuner is capable of tuning to all of the available channels simultaneously, a single tuner may operate such that it provides the data necessary to transcode or transmit each of the requested data streams. The distribution unit or the control node may provide for the constant transcoding or channels for transmission, but may selectively transmit only those channels that are requested by one or more receiving units. In this way, there is a rapid channel change as each of the channels which are available are already tuned, the only requirement by the distribution unit or the control node is to alter a particular stream which is sent to a user. It is specifically understood that in some embodiments, a plurality of streams may be sent simultaneously by multiplexing various content streams into a single stream. For example, in one embodiment, there may be a situation in which the current channel that a user is being sent as well as a channel that the user has designated as a favorite. In this way, multiple channels may be sent simultaneously over in a single transmission channel.

Distributing tuning, decoding, decryption, transcoding, IP packetization, VOD service, and access point functionality locally or near the users (at the edge of the network), avoids massive overloading of the cable network or costly CMTS upgrades that are inherently required by a centralized approach and provides a higher quality of service to the end-user (as opposed to if many of these functions were carried out centrally) such as faster channel changes and better quality video. This architecture, coupled with wireless transmission to the user, further allows the distribution platform to act as a “remote set-top box” in cases where drop cable (e.g., a cable is a cable from the trunk to a subscriber) to a subscriber does not exist. In this case, the “mobile device” will be stationary, and will function to convert the Mobile TV signal back to a wired form, such as but not limited to those carried by coax cable, HDMI, S-Video, or component video.

In another embodiment, a reduced functionality version of the distribution unit 104, 106, 108 may be deployed without Wi-Fi access point (WAP) functionality. This type of distribution unit may be used in situations such as, but not limited to, when there is a pre-existing deployment of Wi-Fi access points that can be leveraged by coupling one or many Wi-Fi access points with at least one of the reduced functionality distribution unit 104, 106, 108.

One advantage of the present disclosure is to provide a continuity of service offering to the wired cable TV subscriber using distribution unit Mobile TV. Services available to subscribers through their wired connection are also made available wirelessly. Another advantage of the present disclosure is to provide a continuity of subscribed services for the cable/Mobile TV subscriber. The distribution unit system allows the subscriber to “carry” their customized monthly service so that the same services that the subscriber is subscribed to for delivery to their home location are available through their Mobile TV connection. Yet another advantage of the present disclosure is to provide a seamless integration of the user's viewing experience in which, for example, a user can be viewing, on a mobile device, a program recorded on the user's home PVR (personal video recorder), suspend viewing of the program on the mobile device, and later, continue watching the same program on the home TV or mobile device exactly from where it was suspended. In another example, the user is first watching a program on the home TV, the viewing is then suspended and later the user continues watching the same program on a mobile device from exactly the same point where the user had suspended viewing the program.

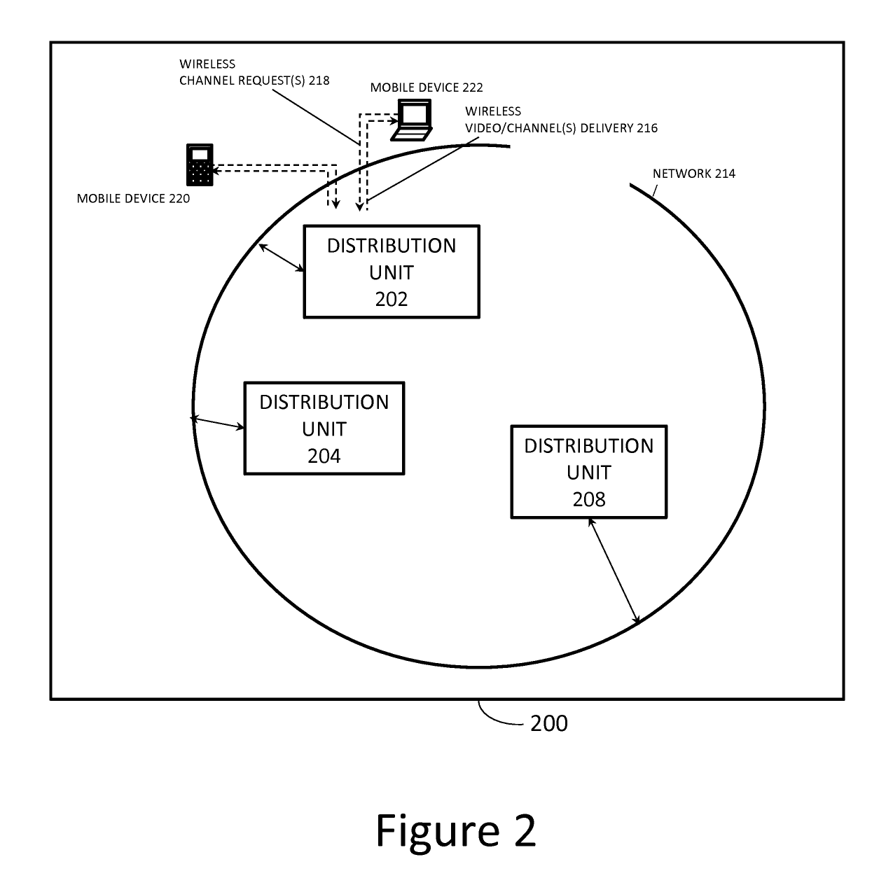

Referring to FIG. 2 shown is a schematic of a Mobile TV delivery system using distribution units 202, 204, 208 which are capable of delivering content from network 214 to mobile devices 220, 222 responsive to channel request(s) 218. The network 214 may be a physical network, such as a cable television coaxial cable network or a wireless network delivery 216 such as, but not limited to, cellular, satellite, or terrestrial television. In one embodiment, the cable television coaxial cable signal is a set of frequency-division multiplexed signals including Quadrature Amplitude Modulated Signal (QAM-64 or QAM-256) comprising of DOCSIS data (Internet-based services such as VoIP and Digital High-Speed Internet Access), Analog Cable TV channels, and/or Digital Cable TV channels.

In another embodiment, with reference to FIG. 2 a Mobile TV system has a cable TV network carrying a cable signal, which is coupled to the network 214 over a geographic area through which the network 214 is deployed. The Mobile TV system comprises a plurality of CSPD devices in the form of distribution unit 202, 204, 208, substantially similar to distribution unit 104, 106, 108. Also coupled to the cable network 214 and the distribution unit 202, 204, 208 is a plurality of stand-alone Wireless Access Points. In some embodiments, the distribution unit 104, 106, 108 and the Wireless Access Points are arranged in a 1:1 configuration, wherein the distribution unit 104, 106, 108 comprises the wireless access points.

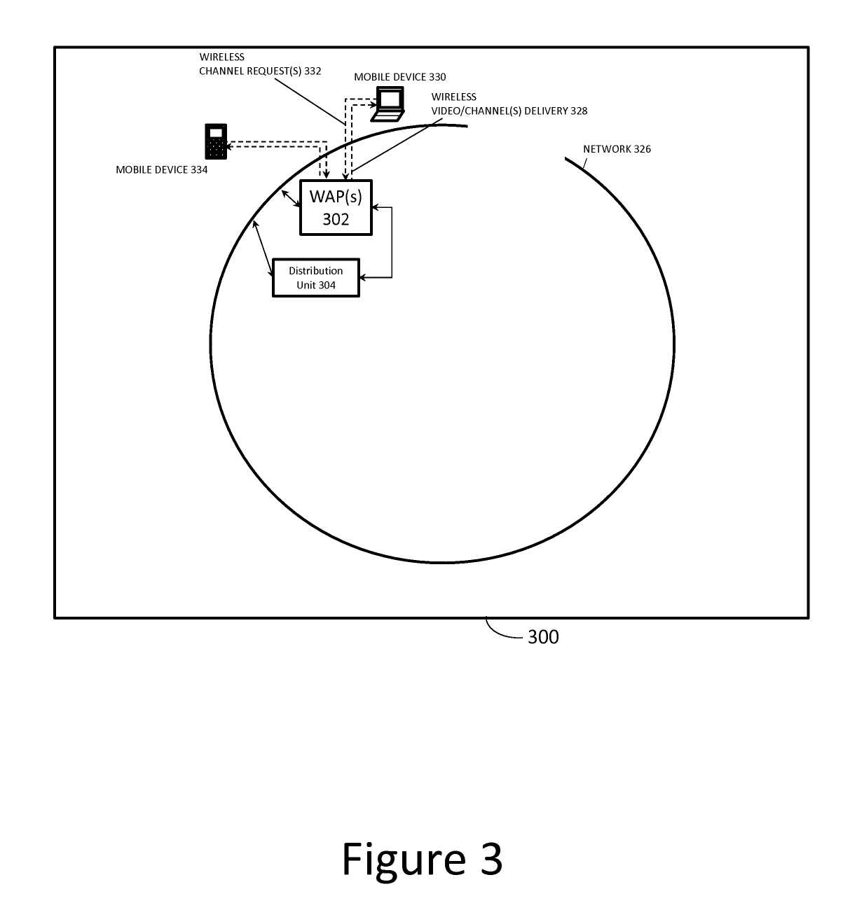

With reference to FIG. 3, the distribution unit 304 has a receiver module coupled to a cable for receiving a cable signal, a signal processing and conversion system (signal converter), a delivery system, and a storage system. The receiver module has a plurality of Tuner/QAM Demodulators and at least one DOCSIS modem(s) that accept the cable signal as an input. The signal converter unit has a decryption module for decrypting conditional-access protected video contents. The signal converter also has a transport stream demultiplexer for separating the at least one video stream from the aggregate decrypted video stream, and a transcoder for altering video bitrates, size, quality, codec format etc. Once transcoded, the video signal may optionally be re-encrypted before delivery to the customer. The delivery system has HTTP and streaming servers and a Wi-Fi Module. The streaming server manages and pushes the video and Mobile TV contents to the transmitter. In other embodiments, the transmitter is a suitable transceiver such as an Ethernet port, an integrated Wi-Fi radio or an external Wi-Fi Access point. The transmitter provides a delivery path to mobile devices requesting Mobile TV services. The storage system stores video contents locally for Video-on-Demand services on the Mobile TV system.

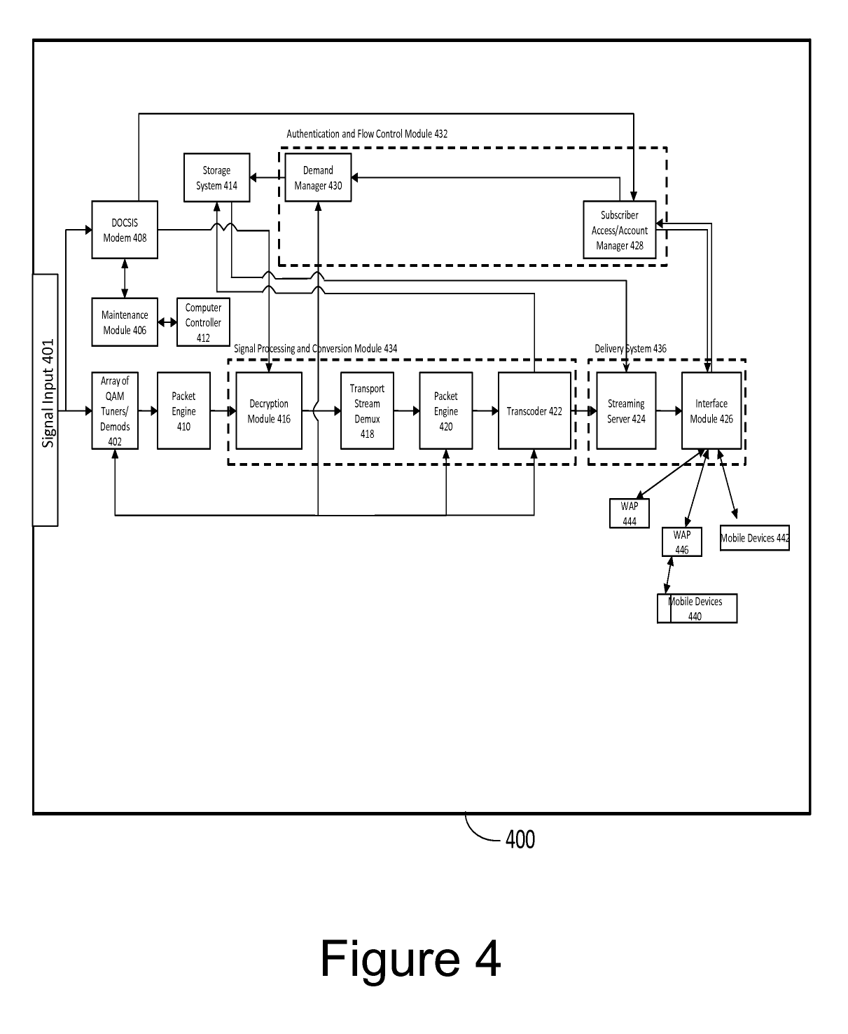

With specific reference to the exemplary embodiment illustrated by FIG. 4, a signal enters the distribution unit has a signal input 401. The signal from signal input 401 is split and used for inputting signals and transmitted to the DOCSIS modem 408 and an array of QAM Tuners/Demods 402. The array of QAM Tuners/Demods 402 transmits at least one IP data stream to a packet engine 410. The packet engine 410 forwards the packets to a signal processing and conversion module 434, and the signal processing and conversion module 434 forwards the output from the signal processing and conversion module 434 to a delivery system 436. The delivery system 436 provides the at least one IP data stream to a plurality of devices. In some embodiments, the delivery system may provide the output to a receiving device 110 through a physical connection such as an Ethernet system, while in other embodiments the delivery system may provide the signal to wireless devices.

The DOCSIS modem 408 receives a split signal from signal input 401, tunes to and demodulates specific frequency bands depending on whether it is a DOCSIS 2.0 or DOCSIS 3.0 band and the mode in which it is currently running (2 channel, 3 channel, or 4 channel bonded or unbonded), processes the signal for IP packets addressed to the mentioned Distribution Unit, and outputs the signal to both a maintenance module 406 and an authentication and flow control module 432. The maintenance module 406 is configured to communicate with a computer controller 412. The authentication and flow control module 432 communicates with a storage system 414 and the delivery system 436. The storage system 414 is configured to communicate also with the delivery system 436.

The authentication and flow control module comprises an on demand manager 430 and a subscriber access/account manager 428. In some embodiments, the subscriber access/account manager 428 communicates with the demand manager 430 and the delivery system 436.

The signal processing and conversion module 434 comprises a decryption module 416, a transport stream demux 418, a packet engine 420, and a transcoder 422. In some embodiments, the decryption module 416 forwards a signal to the transport stream demux 418, the transport stream demux 418 forwards a signal to the packet engine 420, the packet engine forwards a signal to the transcoder 422.

The delivery system 436 comprises a streaming server 424 and an interface module 426. The streaming server 424 transmits a signal to the interface module 426.

The array of QAM/Tuners Demods 402 may be responsible for simultaneously tuning and demodulating one or more 6 MHz channels. The output has a number of transport streams (TS) each at a predetermined rate, for example 38.4 Mb/s. A transport stream is capable of having several MPEG 2/4 elementary streams (where each elementary stream represents data for a TV channel). This array of QAM/Tuners Demods 402 interfaces with the demand manager 430 and the packet engine 420. The demand manager 430 may, in some embodiments, control which 6 MHz channels to tune to based on demand so as to alleviate the system from unnecessary processing. The demodulated TS is fed into the packet engine 420.

The packet engine 410 is, in some embodiments, an intelligent buffer that accepts the transport streams from the array of QAM tuners/demods 402. The packet engine 410 then selectively feeds buffered packets to the decryption module 416 in the signal processing and conversion module 434 at a controlled data rate. This involves a queue processing technique that is optimized to reduce or avoid the forming of a bottleneck.

Data may enter the signal processing and conversion module 434 through the packet engine 410 as described above and pass data into the decryption module 416. The decryption module 416 may use Entitlement Control Messages (ECM) and Entitlement Management Messages (EMM) or, utilizes the DOCSIS modem to download DRM decryption keys to decrypt TS packets received as input from the Packet Engine 410. The output from the decryption module 416 is decrypted and passed to the transport stream demultiplexer 418. In some embodiments the decryption module uses DRM keys to decrypt VOD IP Video data that is then forwarded to the transport stream demultiplexer 418. In other embodiments, the decryption module may incorporate a separate Cable-Card Access System (CAS) module, or may employ a downloadable conditional access system (DCAS).

The transport stream demultiplexer 418 receives data from the decryption module 416 and demultiplexes the TS into its constituent MPEG 2/4 elementary streams (ES). Each ES represents a single HD or SD TV channel. The ES are sent to a packet engine 420 for buffering. The packet engine 420 takes MPEG 2/4 ES as its input from the TS Demultiplexer and buffers the packets. It may be controlled by the demand manager 430 that guides the packet engine 420 to drop ES packets that are not in demand. The ES packets are then forwarded to the transcoder 422 using a queue processing technique to reduce bottlenecks.

The transcoder 422 takes packets, such as SD/HD MPEG 2/4 ES packets from the packet engine 420 and re-encodes them in a format such as, but not limited to, MPEG4 packets that are compatible in resolution and frame rate with the receiving unit 110. The transcoder 422 also accepts VOD IP Video packets from the decryption module 416 and converts them into a codec compatible in resolution and frame rate with the receiving unit 110. It is expressly understood that a secondary advantage of this conversion prior to storage of IP Video packets is to reduce the size of the data load of the content.

The streaming server 424 accepts the ES input streams, manages the communications and service, and delivers the ES streams channels to the mobile devices using the interface module 426 over wireless or wired connections.

Within the authentication and flow control module, the demand manager 430 and subscriber access/account manager 428 authenticate users and provide flow control to the outgoing streams. The demand manager 430 tracks the channels being serviced at any given time and ensures that the array of QAM tuners and demods 402 and the packet engine 420 tune, decode, and output only the channels in demand. Demand manager 430 may also keeps track of the VOD playback and ensures delivery of the video and activation of the VOD controls such as video forward, rewind, pause, and resume video functions.

In one embodiment, the subscriber access/account manager module 428, also within the authentication and flow control module 432, downloads the subscriber access tables from the head-end through the DOCSIS modem 408 and forwards the subscriber access tables to the native application on the receiving device 110. The subscriber access/account manager module 428 also receives messages from the receiving device 110 (i.e. subscriber authorization requests, handshake requests, channel change request, etc.) through the interface module 426 and relays demand information to the demand manager 430.

The DOCSIS Cable Modem 408 allows internet access and remote networking capabilities over the cable system. The DOCSIS Cable Modem 408 may include a dedicated tuner, or may use output of array of QAM tuners/demods 402. The DOCSIS Cable Modem 408 is responsible for receiving and downloading Video-on-Demand contents (when VoD is provided through IP, as opposed to QAM/MPEG-TS), subscriber access tables, configuration commands, diagnostic information as well as transmitting messages back to a server system running a distribution unit software at the cable operator's central offices or head-ends.

In one embodiment, the storage system 414 may be configured to stores video content that is used in delivery of VOD. This video content can be directly sent to the streaming server 424 as it has already been processed prior to storage. The storage system may also hold user-account credentials or other data required for system or service maintenance.

The maintenance module 406 allows the distribution unit to be remotely configured and updated. It may be connected to the head-end through the DOCSIS Cable Modem 408 and can accept firmware updates, configuration commands, diagnostic info etc. through a file transfer protocol (FTP) or a web-based interface. The maintenance module 406 is configured to be in communication with the computer controller 412 that maintains logic used to program the maintenance module 406 or to execute commands obtained from the maintenance module 406.

It is expressly understood that various elements of the forgoing figure could be subsumed with equivalents based upon varying design requirements. For example, the signal input, in some embodiments, could provide power using an approximately 40 to 87 V alternating current (AC) quasi-square wave, at approximately 47 to 63 Hz, through a threaded interface simultaneously with the actual content which is used by the DOCSIS modem 408 and the array of QAM tuners/demods 402. In another example, the DOCSIS modem could be replaced with a cellular or other modem that does not receive input from the signal input 401. In yet another example, part or all of the elements within FIG. 4 may be deployed in a control node rather than an individual distribution node. FIG. 4 is intended to illustrate a non-limiting exemplary illustration of one type of distribution unit.

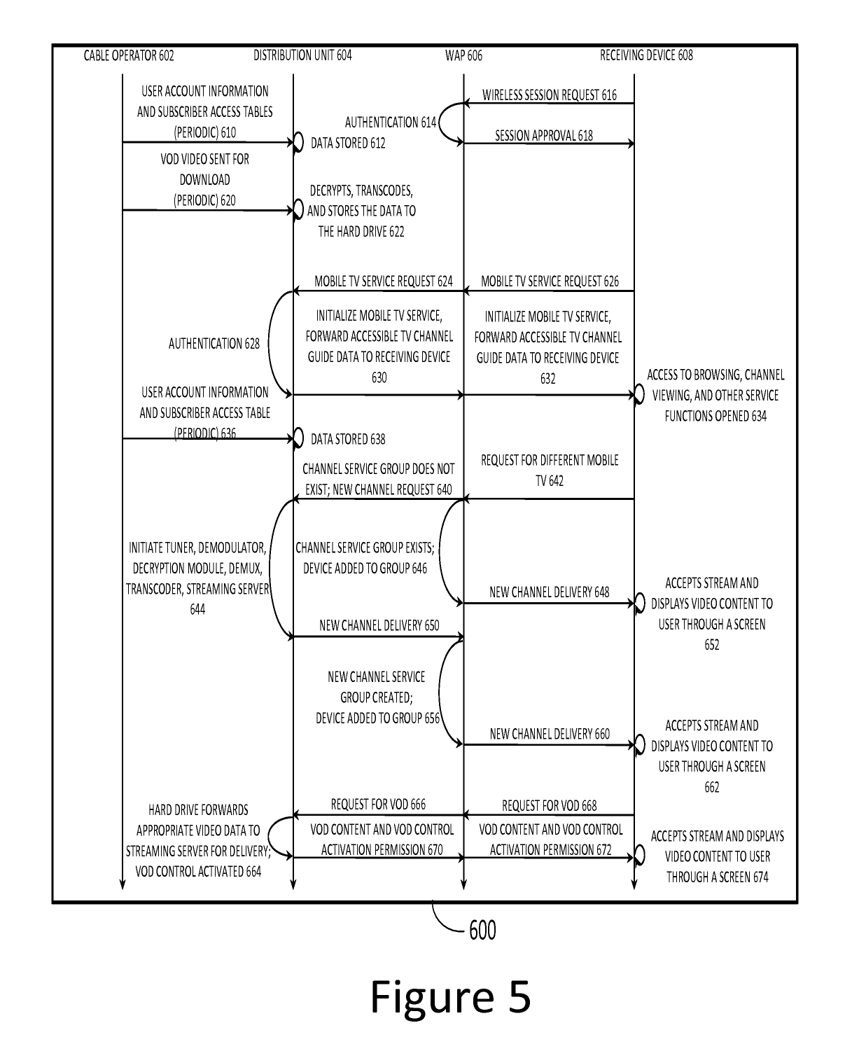

FIG. 5 is a flow diagram 600 illustrating one example communication routine between a cable operator 602, a distribution unit 604, a WAP 606, and a receiving device 608. The cable operator 602 may operate substantially similarly to the control node 102, the distribution unit 604 may operate substantially similarly to the distribution units 104, 106, 108, and the receiving device 608 may be substantially similar to receiving device 110.

In this embodiment, the user account information and subscriber access tables 610 are periodically updated from the cable operator 602 and stored in the distribution unit 604. The user account information and subscriber access tables 610 are stored 612 in the distribution unit 604. In one embodiment, the receiving device 608 sends a wireless session request 616 to WAP 606. The wireless session request 616 is authenticated 614 using data stored 612 in the distribution unit 604. Upon successful authentication 614, the WAP 606 sends a session approval message 618 to the receiving device 608. At periodic intervals, the cable operator 602 provides VOD video for download 620 that is decrypted, transcoded, and stored 622 in the distribution unit 604. When the receiving device 608 makes a service request 626, the service request 626 passes through the WAP 606. The WAP 606 places a Mobile TV service request 624 to the distribution unit 604. The distribution unit 604 authenticates 628 the Mobile TV service request 624. Upon successful authentication 628, the distribution unit 604 initializes the Mobile TV service and forwards an accessible TV channel guide data to the receiving device 630. The WAP 606 initializes the Mobile TV service and forwards an accessible TV channel guide data to the receiving device 632. The receiving device is then given access to browsing, channel viewing, and other service functions opened 634. While the user has access to browsing, channel viewing, and other service functions the user account information and subscriber access table may again be periodically updated 636. The periodic update of the user account information and subscriber access table may be stored in the distribution unit 604.

The receiving device may create a request for different Mobile TV content 642. If the different Mobile TV is already being sent by the distribution device 604, the receiving device 608 is added to the group receiving the channel 646 and the WAP initiates a new channel delivery 648 and provides the different Mobile TV content to the receiving device 608 and the receiving device 608 accepts the stream and displays video content to a user using a screen 652.

If the different Mobile TV is not already being sent by the distribution device 604, a new channel service group is created 656, and the WAP 606 initiates a new channel request 640, and the distribution unit 604 initiates a tuner, demodulator, decryption module, demux, transcoder and streaming server change 644 to create a new channel delivery 660. When the new channel delivery is created 660, the WAP 606 adds the channel to the group present available 646. The WAP 606 and provides the different mobile tv content to the receiving device 608 and the receiving device 608 accepts the stream and displays video content to a user using a screen 662.

In some embodiments, the receiving device 608 may make a request for VOD 668 to the WAP 606 that forwards a request for VOD 666 to the distribution device 604. The distribution device 604 access the VOD data and uses a storage mechanism, such as a hard drive, to forward appropriate video data to the streaming server within the distribution device 604 for delivery upon the activation of the VOD control 664. Video content and VOD control activation permissions is then sent 670 to the WAP 606, and the WAP 606 forwards the VOD content and control activation permission to the receiving device 672. The WAP 606 and provides the different Mobile TV content to the receiving device 608 and the receiving device 608 accepts the stream and displays video content to a user using a screen 674.

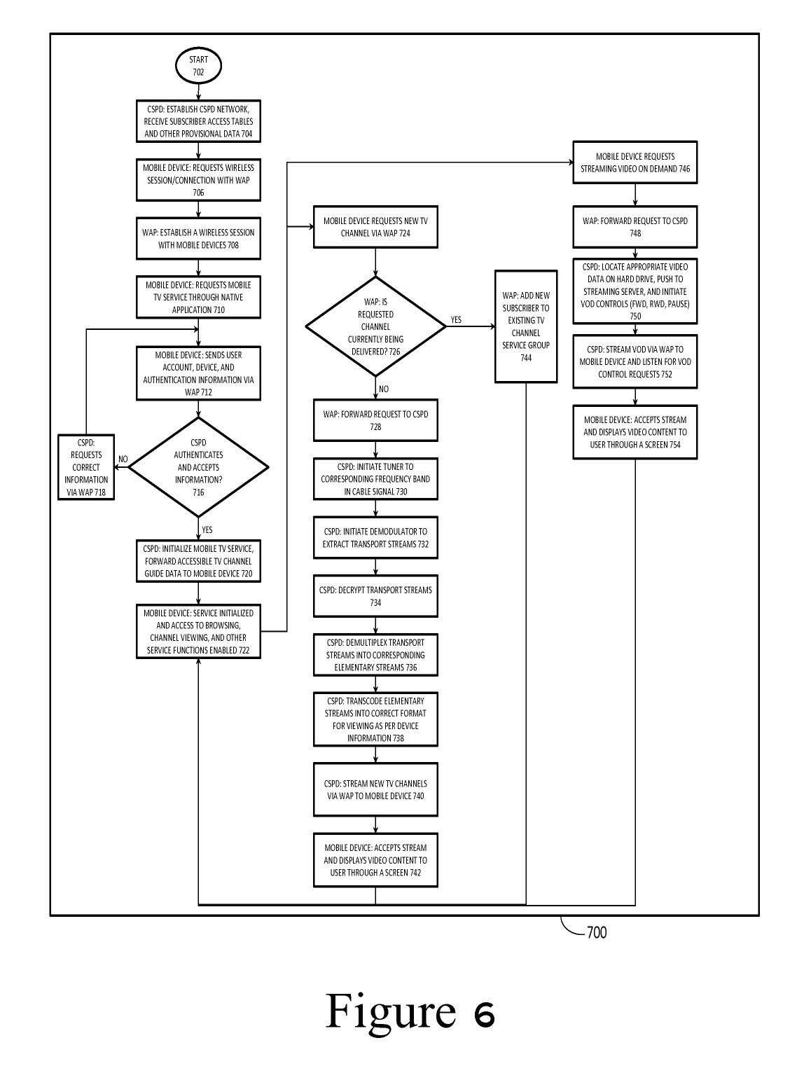

FIG. 6 is a flowchart 700 illustrating one embodiment of service communications and delivery processes. In step 704, a CSPD is used to establish a network and receive subscriber access tables and other provisional data. In step 706, a mobile device requests a wireless session and connects with a WAP. In step 708, the WAP establishes a wireless session with a mobile device. In step 710, the mobile device requests Mobile TV service. This request may use an application that is native to the mobile device, such as a web browser that is preloaded onto the mobile device. In step 712, the mobile device sends user account, device, and authentication information via WAP 712. In step 716, the CSPD attempts to authenticate the information. If the CSPD rejects the authentication information, the CSPD requests correct authentication information via the WAP in step 718. If the CSPD accepts the authentication information, the CSPD initializes the Mobile TV service and forwards accessible TV channel guide data to the mobile device in step 720. Upon receipt of the accessible TV channel guide data by the mobile device, the mobile device obtains access to browsing, channel viewing, and other service functions in step 722. The mobile device may request data, for example the mobile device requests new TV channels via WAP in step 724 or the mobile device may request streaming video on demand in step 746.

Upon the mobile device requesting a new TV channel via WAP in step 724, the WAP determines if the channel is currently being sent to the WAP or being delivered to another mobile device in step 726. If the channel is currently being sent to the WAP or being delivered to another mobile device, the WAP adds the mobile device as a subscriber to the existing TV channel service group in step 744 and allows the user to return to a state substantially similar to the state found in step 722.

From step 722 and if the WAP indicates that the requested channel is not being currently delivered in step 726, in step 728 the WAP forwards the channel request to the CSPD. The CSPD initiates a tuner to tune to a corresponding frequency band in a cable signal in step 730, and then initiates a demodulate to extract transport streams that correspond to the corresponding frequency band in step 732. In step 734 the CSPD decrypts the extracted transport streams. In 736 the CSPD demultiplexs the decrypted transport streams into elementary streams, and in step 738 the CSPD transcodes the elementary streams into correct viewing for a device as requested by the receiving device or known as a provide of the receiving device. In step 740, the CSPD streams new TV channels through a WAP to the mobile device, and in step 742 the mobile device accepts the stream and plays video content to a user through a screen. The user may view the content and be a state substantially similar to the state found in step 722.

If the mobile device in step 722 requests a video on demand service in step 746, the WAP forwards the request to the CSPD in step 748. The CSPD locates the appropriate video data on a storage medium, such as a hard drive, and pushes the medium to a streaming service in a distribution unit while initiation VOD controls in step 750. After initiation of the VOD controls, the CSPD streams VOD via a WAP to a mobile device and listens for VOD control requests in step 752. In step 754 the mobile device accepts stream content and displays video content to a user through a screen. After step 754, the user may view the content and be a state substantially similar to the state found in step 722.

It is understood that at least seven different ways of selecting a channel may be performed by a user in step 722. These seven ways are intended to be illustrative rather than limiting.

The first way of selecting a channel is to manually dial channel number—the native application verifies with the “Accessible Channels Table” to ensure that the requested channel is accessible by the receiving device. If the user account corresponding to the receiving device is authorized to access the channel, the receiving device is then listed in the appropriate channel service group for that Mobile TV channel. If the user account corresponding to the receiving device is not authorized to view the channel, the currently tuned channel remains on screen and a local message pop-up notifies the user.

The second way of selecting a channel is through physical or virtual (e.g., displayed on a screen) channel change buttons, such as an up or down button. When used, the channel changes to the next readily available and accessible channel.

The third way of selecting a channel is through the guide. The guide contains a list of available channels and content presently on the channels. If the guide is not accessible, the guide remains on the screen and a local message popup notifies the user that the channel is not part of the service package.

The fourth way of selecting a channel is through the recall button, which returns the receiving device to the previous channel, selected.

The fifth way of selecting a channel is through a favorite button that returns the receiving device to a previously designated favorite channel.

The sixth way of selecting a channel is through a VOD Request which accesses video which has been previously stored in a matter which is accessible to the CPSD.

The seventh way of selecting a channel is through a genre based selection technique. This technique allows a user to select a channel based upon a predetermined genre such as sports, comedy, etc. This technique may further allow the user to select a random channel matching the genera or a channel that is already in use by other users. By directing the user towards channels already in use, the distribution unit may reduce the overall overhead of the system and minimize the incremental increase caused by the user.

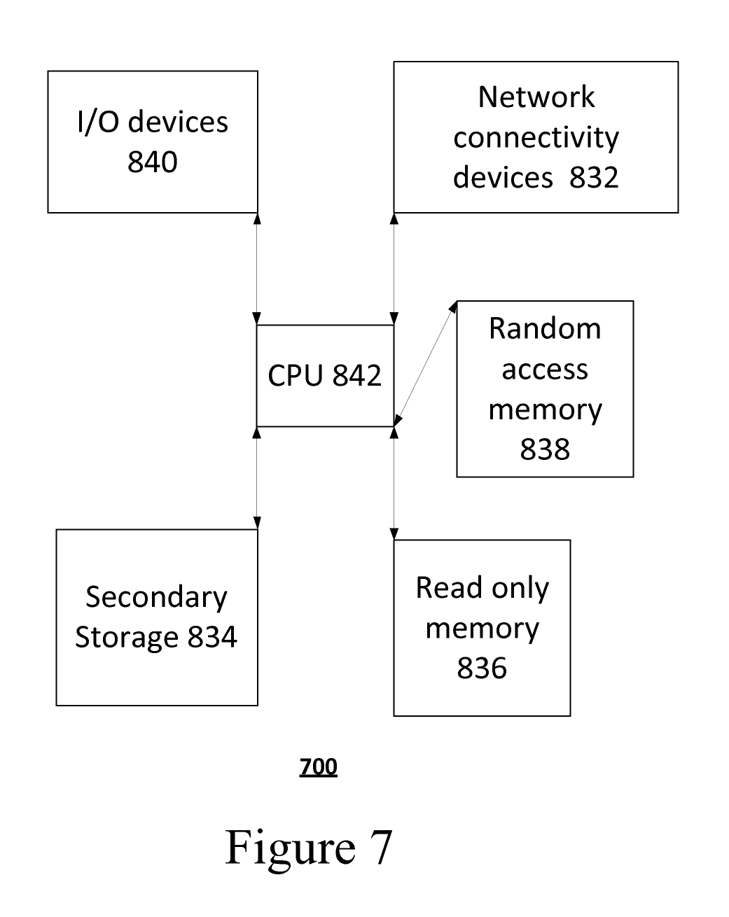

The systems and methods described above may be implemented on any system with sufficient processing power, memory resources, and network throughput capability to handle the necessary workload placed upon it. FIG. 7 illustrates a system 800 suitable for implementing one or more embodiments of a distribution unit to respond to requests for content as disclosed herein. The system 800 includes a processor 842 (which may be referred to as a central processor unit or CPU) that is in communication with memory devices including secondary storage 834, read only memory (ROM) 836, random access memory (RAM) 838, input/output (I/O) 840 devices, and network connectivity devices 832. The processor may be implemented as one or more CPU chips.

The secondary storage 834 is typically comprised of one or more disk drives or tape drives and is used for non-volatile storage of data and as an over-flow data storage device if RAM 138 is not large enough to hold all working data. Secondary storage 834 may be used to store video on demand content that is transmitted through the network connectivity devices 832. The ROM 836 is used to store instructions and perhaps data that are read during program execution. ROM 836 is a non-volatile memory device that typically has a small memory capacity relative to the larger memory capacity of secondary storage. The RAM 838 is used to store volatile data and perhaps to store instructions. Access to both ROM 836 and RAM 838 is typically faster than to secondary storage 834.

I/O 740 devices may include printers, video monitors, liquid crystal displays (LCDs), touch screen displays, keyboards, keypads, switches, dials, mice, track balls, voice recognizers, card readers, paper tape readers, or other well-known input devices. Network connectivity devices 832 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 832 devices may enable the processor 842 to communicate with an Internet or one or more intranets. With such a network connection, it is contemplated that the processor 842 might receive information from the network, or might output information to the network in the course of performing the above-described method steps. Such information, which is often represented as a sequence of instructions to be executed using processor 842, may be received from and outputted to the network, for example, in the form of a computer data signal embodied in a carrier wave.

Such information, which may include data or instructions to be executed using processor 742 for example, may be received from and outputted to the network, for example, in the form of a computer data baseband signal or signal embodied in a carrier wave. The baseband signal or signal embodied in the carrier wave generated by the network connectivity 832 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 842 executes instructions, codes, computer programs, scripts which it accesses from hard disk, floppy disk, optical disk (these various disk based systems may all be considered secondary storage 834), ROM 836, RAM 838, or the network connectivity devices 832. The processor 842 may consist of multiple processor units including multiple general-purpose processors and multiple processor cores used to accelerate specific functions, such as accelerating transcoding functions.

In one embodiment, the distribution unit 104, 106, 108 will have full access to all of the accessible content that the control node 102 contains. This may be done by the head end treating the distribution unit 104, 106, 108 as a trusted set top box through the receipt of an entitlement control message (ECM) down the cable from the head end. This ECM will contain an encrypted control word that was used to encrypt the content. Each control word can be used to decrypt one specific channel in a 6 MHz band. The distribution unit 104, 106, 108 will receive an entitlement management message (EMM) from the control node 102 that will give the distribution unit 104, 106, 108 authority to decrypt the ECM and unscramble the channel. When a control word is changed this process will get repeated to ensure that the distribution unit 104, 106, 108 is able to unscramble the channel and continue to deliver content to the receiving device 110.

As a result of the receiving device 110 not in direct communication with the control node 102, in some embodiments the control node 102 will not be able to track viewing and perform the digital rights management for the receiving device 110. As such there may be a need to be a method implemented to hide the receiving device 110 behind the distribution unit 104, 106, 108 when content is be decrypt but not hide behind the distribution unit 104, 106, 108 for access control and authorization. This will be done using control messages passed back to the head end.

When a receiving device 110 connects to the distribution unit 104, 106, 108, the receiving device 110 may be masqueraded by the receiving device 110. To the network it will appear that distribution units 104, 106, 108 are connecting as a single device regardless of the number of receiving device connected to one particular distribution unit 104, 106, 108. The distribution unit 104, 106, 108 will be responsible for handling all EMM/ECM messages with the head end for each connected receiving device. The code word received in the ECM by the distribution unit 104, 106, 108 will be used to decrypt a program in the transport stream. Once this program has been decrypted, the stream will be passed to the transcoder.

After transcoding, the content is ready to be sent to the receiving device 110. To do this, a DRM scheme may be used. The distribution unit 104, 106, 108 will use asynchronous encryption (ex. RSA) and pass its public certificate to the receiving device 110. The receiving device 110 will accept and validate the certificate and upon validation will send a session key. The key will then be used with synchronous encryption (ex. AES-128) for the duration of the communication. A single distribution unit 104, 106, 108 will contain a list of session keys, IP address and MAC address for all receiving devices connected to it. The distribution unit 104, 106, 108 will expire a session key after a set time interval. At the end of this time interval, the distribution unit 104, 106, 108 will send a request message to the receiving device and will be sent a new session key. This will ensure that the keys remain secure.

The receiving device 110 can now be added to the broadcast group that is viewing a particular program stream. If one doesn't already exist then it will be created, consistent with the embodiment disclosed in FIG. 5. This group will all be getting the same stream sent to them. There can be more than one group for a single program stream if the need arises for the output of streams to receiving device 110 transcoded differently. The distribution unit 104, 106, 108 may try to decrease the occurrence of multiple groups for a single program stream by transcoding at a bitrate that can be viewed on all of the receiving devices.

In some embodiments, it the distribution unit 104, 106, 108 will continue to reduce the number of multiple groups as long as it doesn't have an adverse effect on the quality the image. This may be determined using the minimum and maximum for particular screen size for a receiving device. Each group will have a control word that will be used to encrypt the content. This code word will be sent to the receiving device using AES to ensure a secure connection. This code word will then be used to encrypt the content using a cable labs approved scheme. The code word will be updated when an ECM message is sent to the distribution unit 104, 106, 108. This will ensure that the CA schemes done by the MSO's will be maintained. New code words will be selected in such a way that they cannot be guessed using the previous code word. The code word will also be changed if it is determined that an unauthorized receiving device is in a particular group. When this is determined, a new code word will be sent to all authorized receiving devices thus making the previous one invalid and once again inaccessible to the unauthorized user(s).

The encrypted transcoded stream will then be transmitted either wirelessly (or wired to a wireless access point) to the receiving device.

When the user tries to access a program on the receiving device, the receiving device will first check to see if there is a session id and a signed checksum of the session id. It will then forward these items as well as a connection request to the distribution unit 104, 106, 108. The distribution unit 104, 106, 108 will ensure that the session id is valid by checking the hash value. If it is valid the receiving device will enter a probationary trusted phase. In this phase, the distribution unit 104, 106, 108 will treat the receiving device as an authenticated device. The receiving device will pass a channel key, its session id and the channel id to the distribution unit 104, 106, 108 for the program that it wants to access. This channel key will get encrypted and using the channel id (which is unique to a program) and the session id, and then signed by the central server or control node 102. The channel keys will be generated by a central server or control node 102 and sent to the receiving device when the session key is created. The distribution unit 104, 106, 108 will validate the channel key to determine if the receiving device 110 is permitted to view a program. If the key is valid, the distribution unit 104, 106, 108 will determine what band the program is in and begin to transcode and transmit it. The distribution unit 104, 106, 108 will then send a request to the central server to ensure that the session id is correct and that the receiving device 110 is authorized to view the program. If the session id is no longer valid, the distribution unit 104, 106, 108 will request the receiving device 110 to re-authenticate itself. If this request comes back invalid, the distribution unit 104, 106, 108 will change the code word used to do encryption to stop the receiving device from viewing the content. If the central server informs the distribution unit 104, 106, 108 that the receiving device is not authorized to view a program, the distribution unit 104, 106, 108 will once again change the code word used to encrypt the content to lock out the receiving device 110. The locked out receiving device 110 will display a message informing the user that it is not authorized to access the program.

When the user first logs in he or she will have to supply a user name and password to log into their account. This communication will be encrypted through SSL. The distribution unit 104, 106, 108 will receive the user name and password and send it to a central server or a control node 102. This central server or control node 102 will authenticate the credentials against a database and send a response to the distribution unit 104, 106, 108. These account credentials will be created during the registration process. The user will have the option of saving the username and password so that it does not need to be entered in all of the time. Upon success a session id as well as channel keys that the receiving device is permitted to view will be passed to the sparrow box that it will forward to the receiving device. The receiving device 110 will also use this session id to authenticate itself with other distribution unit 104, 106, 108 as well as when it's trying to receive premium content. The MD5 checksum of the session id will be signed by the central server to ensure that its validity can be checked by an distribution unit 104, 106, 108 without communicating to the central server.

When the user tries to purchase premium content, the receiving device will forward the session id to the distribution unit 104, 106, 108. The distribution unit 104, 106, 108 will forward the session id to the central server to ensure that the id is valid. The central server will log the request coming from the distribution unit 104, 106, 108 for the premium content to the account id attached to the session id. Now, two requests for the premium content will be made. One of the requests will be by the account in the session and one will be sent by the distribution unit 104, 106, 108. The first request will be sent to the billing server so that the account can be properly billed. The second request will be used for the actual content delivery. This will ensure that the distribution unit 104, 106, 108 will receive all of the ECM and EMM messages required to view the programming. This will ensure that the MSO can properly bill the user for the premium content and also so that the distribution unit 104, 106, 108 can properly decode the stream. At this point the distribution unit 104, 106, 108 will treat this premium content the same as it does for non-premium content.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

1. A distribution unit for delivering content to a mobile device, comprising:
an input for receiving an input signal comprising a multimedia content;
an authentication module that is configured permit authentication of a mobile device to view the multimedia content;
a signal processing and conversion module for transcoding the multimedia content for a destination platform; and
a delivery system for distributing the multimedia content.

2. The distribution unit of claim 1, wherein the delivery system comprises a wireless interface.

3. The distribution unit of claim 1, wherein the delivery system comprises a wireless and a wired interface.

4. The distribution unit of claim 1, further comprising a local storage for transmitting multimedia content on demand to the mobile device.

5. The distribution unit of claim 1, further comprising an array of tuners for simultaneously tuning to a plurality of frequencies provided by the signal.

6. The distribution unit of claim 1, further comprising a power supply capable of receiving a power input from the input signal.

7. A system for distributing content to a plurality of devices, comprising:
a control node;
a plurality of distribution units in communication with the control node, wherein the plurality of distributions units are configured to provide Mobile TV to at least one receiving device, wherein the control node provides information relating to the account status of the at least one receiving device and designates content from which the at least one receiving device may select.

8. The system of claim 7, wherein the control node communicates to the distribution units using a cellular network.

9. The system of claim 8, wherein the plurality of distribution units each receive content to be delivered as Mobile TV from a physical cable installation.

10. The system of claim 8, wherein at least one of the plurality of distribution units receive power from the physical cable installation.

11. The system of claim 8, wherein the plurality of distribution units each receive content to be delivered as Mobile TV from a satellite.

12. A cable TV signal processing device, for operation in a cable TV network transmitting a cable signal having cable TV channels, comprising:
a distribution unit for receiving the cable TV signal from the cable TV network, the distribution unit having a tuner system for extracting at least one TV channel of the cable TV channels;
a signal converter coupled to the distribution unit for converting the at least one TV channel into respective at least one mobile TV channel each comprising streaming packetized data; and
a transmitter coupled to the signal converter for transmitting the at least one mobile TV channel.

13. A cable TV signal processing device according to claim 12 wherein the receiver, the signal converter, and the transmitter are housed in one unit.

14. A cable TV signal processing device according to claim 12 wherein the transmitter comprises a wireless access point module coupled with a streaming server for transmitting the at least one mobile TV channel to a receiving device.

15. A cable TV signal processing device according to claim 12 wherein the transmitter comprises a wireless access point module coupled with a streaming server for transmitting the at least one mobile TV channel to an external wireless access point (WAP) device.

16. A cable TV signal processing device according to claim 12 wherein the transmitter comprises an Ethernet wire interface coupled with a streaming server for transmitting the mobile TV channels to a wireless access point (WAP) device.

17. A cable TV signal processing device according to claim 13 comprising a storage system for video content storage for on-demand playback.

18. A mobile TV system, for operation in a cable TV network transmitting a cable TV signal having at least one cable TV channel, the mobile TV system comprising:
a plurality of wireless access points, installed over a geographic area and coupled to the cable TV network;
a plurality of cable TV signal processing devices installed over the geographic area and coupled to the cable TV network for receiving the cable TV signal from the cable TV network, each one of the cable TV signal processing devices is communicatively coupled to at least one of the wireless access points; and
a plurality of mobile devices for requesting cable TV channel access and for receiving cable TV channels; wherein each one of the cable TV signal processing devices, in response to requests for desired channels from at least one of the mobile devices, splits the cable TV signal into at least one cable TV channels for conversion to at least one mobile TV channels and communicates at least one of the mobile TV channels to at least one of the wireless access points and at least one of the wireless access points transmits at least one of the mobile TV channels to at least one of the requesting mobile devices.

19. A mobile TV system according to claim 18 wherein at least one of the cable TV signal processing devices and at least one of the wireless access points are housed in the same enclosure.

20. A mobile TV system according to claim 18 wherein at least one of the cable TV signal processing devices and at least one of the wireless access points are communicatively coupled by means of a wireless connection.

21. A mobile TV system according to claim 18 wherein at least one of the cable TV signal processing devices and at least one of the wireless access points are communicatively coupled by means of a wired connection.

22. A mobile TV system, for operation in a cable TV network transmitting a cable TV signal having at least one cable TV channel, comprising:
a plurality of cable TV signal processing devices, installed over a geographic area and coupled to the cable TV network for receiving the cable TV signal from the cable TV network, each cable TV signal processing device comprising a Wi-Fi Wireless access point module; and
a plurality of mobile devices for requesting of cable TV channel access and receiving cable TV channels; wherein each one of the plurality of cable TV signal processing devices, in response to requests for desired channels from at least one of the mobile devices, splits the cable TV signal into at least one cable TV channels for conversion to at least one mobile TV channels; and transmits at least one of the mobile TV channels to at least one of the requesting mobile devices.

23. A mobile TV system according to claim 22 comprising a plurality of wireless access points installed over a geographic area and wherein at least one of the cable TV signal processing devices and at least one of the wireless access points are communicatively coupled by means of a wireless connection.

24. A mobile TV system according to claim 22, wherein the mobile TV system downloads and stores on-demand video content IP (Internet Protocol) data from the cable TV network, the IP data being addressed to at least one of the cable TV processing devices in the mobile TV system.

25. The system of claim 8, wherein the receiving device is a handheld mobile device.
